(19) United States
(12) Patent Application Publication
(10) Pub. No.: US 2025/0076121 A1
(43) Pub. Date: Mar. 6, 2025

(54) CALIBRATION MEMBER, CALIBRATION APPARATUS, CALIBRATION METHOD, AND CALIBRATION PROGRAM

(71) Applicant: FUJIFILM CORPORATION, Tokyo (JP)

(72) Inventor: Yu MISHIMA, Tokyo (JP)

(21) Appl. No.: 18/948,528

(22) Filed: Nov. 15, 2024

Related U.S. Application Data
(63) Continuation of application No. PCT/JP2023/019887, filed on May 29, 2023.

(30) Foreign Application Priority Data
May 31, 2022 (JP) 2022-088989

(51) Int. Cl. G01J 3/52; G01J 3/02

(52) U.S. Cl. CPC G01J 3/524; G01J 3/0297

(57) ABSTRACT

Provided is a calibration member including an imaging target surface, in which the imaging target surface includes a central region, a frame surrounding an outer edge of the central region, a pair of first patch groups including a plurality of patches that extend in a first direction and facing each other with the central region interposed therebetween, and a pair of second patch groups including a plurality of patches that extend in a second direction intersecting the first direction and facing each other with the central region interposed therebetween, and the calibration member is for performing, by using the patches, calibration with respect to an image obtained by imaging the imaging target surface.

### CROSS-REFERENCE TO RELATED APPLICATIONS

This application is a continuation application of International Application No. PCT/JP2023/019887, filed on May 29, 2023, which is incorporated herein by reference in its entirety. Further, this application claims priority from Japanese Patent Application No. 2022-088989, filed on May 31, 2022, the disclosure of which is incorporated by reference herein in its entirety.

### BACKGROUND

### Technical Field

The present disclosure relates to a calibration member, a calibration apparatus, a calibration method, and a non-transitory storage medium storing a calibration program.

### Related Art

In the related art, a technique of measuring the amount of energy by using a color forming member that forms a color in accordance with the amount of energy in a case where energy (for example, pressure or ultraviolet rays) is applied thereto is known. Examples of such a color forming member include PRESCALE (registered trademark) (manufactured by FUJIFILM Corporation) with which a color formation density corresponding to applied pressure can be obtained.

For example, disclosed in JP2015-215291A is a technique in which a sheet-shaped marker is imaged after being placed on a color forming sheet (for example, PRESCALE) that forms a color in a certain relationship with the value of energy applied thereto, the inclination, the distance, the waviness, and the color of an captured image are corrected by using the marker included in the captured image, and the density of the color of the color forming sheet included in an image after the correction is converted into an energy value. In addition, for example, described in WO2021/235364A is a technique in which a pressure measurement sheet (for example, PRESCALE) is imaged after being displaced on a calibration sheet, the density, the size, the distortion, and the shape of a captured image are corrected based on the calibration sheet included in the captured image, and a density value of the pressure measurement sheet included in an image after the correction is converted into a pressure value.

Meanwhile, in a case where a user performs the imaging of a color forming member and a calibration member, an appropriate image may not be obtained with the color forming member and the calibration member not being appropriately included in the angle of view or with the color forming member and the calibration member being imaged with inclination. In a case where an appropriate image is not obtained, correction of the color, the distortion, the inclination, the size, and the like of an image may not be appropriately performed, and measurement of the amount of energy may not be appropriately performed.

### SUMMARY

The present disclosure provides a calibration member, a calibration apparatus, a calibration method, and a non-transitory storage medium storing a calibration program that support appropriate measurement.

According to a first aspect of the present disclosure, there is provided a calibration member comprising an imaging target surface. The imaging target surface includes a central region, a frame surrounding an outer edge of the central region, a pair of first patch groups including a plurality of patches that extend in a first direction and facing each other with the central region interposed therebetween, and a pair of second patch groups including a plurality of patches that extend in a second direction intersecting the first direction and facing each other with the central region interposed therebetween, and the calibration member is for performing, by using the patches, calibration with respect to an image obtained by imaging the imaging target surface.

According to a second aspect of the present disclosure, in the calibration member according to the first aspect, the frame may have a rectangular shape.

According to a third aspect of the present disclosure, in the calibration member according to the first or second aspect, the first patch group and the second patch group may include the plurality of patches having different colors.

According to a fourth aspect of the present disclosure, in the calibration member according to the third aspect, the first patch group and the second patch group may include the plurality of patches having the same hue and different densities.

According to a fifth aspect of the present disclosure, in the calibration member according to any one of the first to fourth aspects, colors and the number of the patches included in one of the pair of first patch groups may be the same as colors and the number of the patches included in the other of the pair of first patch groups, and colors and the number of the patches included in one of the pair of second patch groups may be the same as colors and the number of the patches included in the other of the pair of second patch groups.

According to a sixth aspect of the present disclosure, in the calibration member according to any one of the first to fifth aspects, a color of at least one patch included in the first patch group may be the same as a color of at least one patch included in the second patch group.

According to a seventh aspect of the present disclosure, in the calibration member according to any one of the first to sixth aspects, the number of the patches included in the first patch group and the number of the patches included in the second patch group may be different from each other.

According to an eighth aspect of the present disclosure, in the calibration member according to any one of the first to seventh aspects, the plurality of patches may be the same as each other in at least one of size, shape, or angle.

According to a ninth aspect of the present disclosure, in the calibration member according to any one of the first to eighth aspects, each of the plurality of patches may have a rectangular shape.

According to a tenth aspect of the present disclosure, in the calibration member according to any one of the first to ninth aspects, the imaging target surface may include a blank region disposed between a first patch group and a second patch group included in at least one of combinations of the first patch group and the second patch group that are adjacent to each other in a circumferential direction of the central region and a figure disposed in the blank region.

According to an eleventh aspect of the present disclosure, in the calibration member according to the tenth aspect, the imaging target surface may include four blank regions each of which is disposed between the first patch group and the second patch group that are adjacent to each other in the circumferential direction of the central region, and four figures that are respectively disposed at the four blank regions.

According to a twelfth aspect of the present disclosure, in the calibration member according to the eleventh aspect, shapes of the four figures may be similar to each other.

According to a thirteenth aspect of the present disclosure, in the calibration member according to the eleventh or twelfth aspect, the four figures may be figures respectively showing four corners of a rectangle that has, as parts of sides thereof, line segments disposed on extension lines of outer edges of the pair of first patch groups and the pair of second patch groups.

According to a fourteenth aspect of the present disclosure, there is provided a calibration apparatus comprising at least one processor. The processor is configured to acquire an image including a central region, a frame surrounding an outer edge of the central region, a pair of first patch groups including a plurality of patches that extend in a first direction and facing each other with the central region interposed therebetween, and a pair of second patch groups including a plurality of patches that extend in a second direction intersecting the first direction and facing each other with the central region interposed therebetween and perform calibration with respect to the image by using the patches.

According to a fifteenth aspect of the present disclosure, in the calibration apparatus according to the fourteenth aspect, the processor may be configured to extract the frame from the image and correct at least one of a distortion, an inclination, or a size of the image based on a shape of the extracted frame.

According to a sixteenth aspect of the present disclosure, in the calibration apparatus according to the fourteenth or fifteenth aspect, the processor may be configured to perform calibration by using a part of the plurality of patches included in the first patch group and the second patch group included in the image.

According to a seventeenth aspect of the present disclosure, in the calibration apparatus according to any one of the fourteenth to sixteenth aspects, the central region in the image may include a color forming member, which forms a color with density distribution corresponding to an amount of energy applied thereto.

According to an eighteenth aspect of the present disclosure, in the calibration apparatus according to the seventeenth aspect, the first patch group and the second patch group may include the plurality of patches having different colors, and the processor may be configured to perform calibration of a color of the color forming member included in the image based on colors of the first patch group and the second patch group included in the image.

According to a nineteenth aspect of the present disclosure, in the calibration apparatus according to the eighteenth aspect, the processor may be configured to perform calibration by using a part of the plurality of patches included in the first patch group and the second patch group included in the image, the part of the plurality of patches being determined in advance in accordance with a type of the color forming member included in the image.

According to a twentieth aspect of the present disclosure, in the calibration apparatus according to the eighteenth or nineteenth aspect, the processor may be configured to derive the amount of energy applied to the color forming member based on the color of the color forming member after the calibration by using data in which a relationship between the amount of energy applied to the color forming member and the color of the color forming member included in the image is determined in advance.

According to a twenty-first aspect of the present disclosure, there is provided a calibration method comprising processing of acquiring an image including a central region, a frame surrounding an outer edge of the central region, a pair of first patch groups including a plurality of patches that extend in a first direction and facing each other with the central region interposed therebetween, and a pair of second patch groups including a plurality of patches that extend in a second direction intersecting the first direction and facing each other with the central region interposed therebetween and performing calibration with respect to the image by using the patches.

According to a twenty-second aspect of the present disclosure, there is provided a non-transitory storage medium storing a program that causes a computer to execute calibration processing, the calibration processing including: acquiring an image including a central region, a frame surrounding an outer edge of the central region, a pair of first patch groups including a plurality of patches that extend in a first direction and facing each other with the central region interposed therebetween, and a pair of second patch groups including a plurality of patches that extend in a second direction intersecting the first direction and facing each other with the central region interposed therebetween and performing calibration with respect to the image by using the patches.

The calibration member, the calibration apparatus, the calibration method, and the non-transitory storage medium according to the aspects of the present disclosure support appropriate measurement.

### BRIEF DESCRIPTION OF THE DRAWINGS

FIG. 1 is a diagram showing an example of a schematic configuration of an information processing system.

FIG. 2 is a schematic view showing the way in which a captured image is captured.

FIG. 3 is a view showing an example of a calibration member.

FIG. 4 is a block diagram showing an example of a hardware configuration of an information processing apparatus.

FIG. 5 is a block diagram showing an example of a functional configuration of the information processing apparatus.

FIG. 6 is a diagram showing an example of the captured image.

FIG. 7 is a diagram showing another example of the captured image.

FIG. 8 is a diagram showing an example of a screen displayed on a display.

FIG. 9 is a flowchart showing an example of information processing.

FIG. 10 is a diagram showing an example of the calibration member.

FIG. 11 is a diagram showing an example of the calibration member.

FIG. 12 is a diagram showing an example of the calibration member.

FIG. 13 is a diagram showing an example of the calibration member.

### DETAILED DESCRIPTION

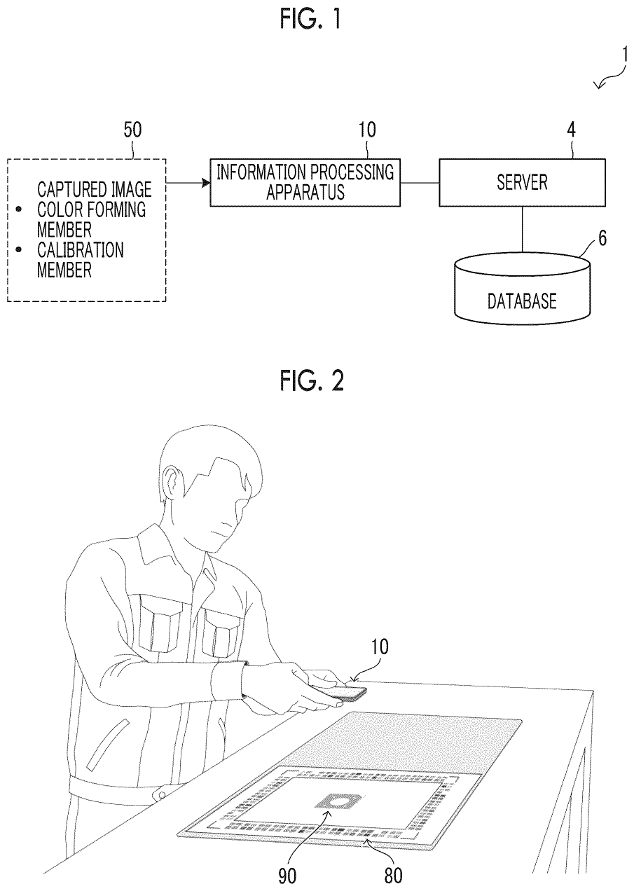

Hereinafter, embodiments of the present disclosure will be described with reference to the drawings. First, a configuration of an information processing system 1 to which a calibration member and a calibration apparatus according to the embodiment of the present disclosure are applied will be described with reference to FIG. 1. FIG. 1 is a diagram showing a schematic configuration of the information processing system 1. The information processing system 1 includes an information processing apparatus 10, a server 4, and a database 6. The information processing apparatus 10 and the server 4 are connected to each other such that the information processing apparatus 10 and the server 4 can communicate with each other via a wired or wireless network.

The information processing system 1 of the present exemplary embodiment is a system for measuring the amount of energy by using a color forming member 90 that forms a color with density distribution corresponding to the amount of energy applied thereto in a case where energy (for example, pressure, heat, and ultraviolet rays) is applied thereto. Specifically, the information processing apparatus 10 acquires an image obtained by imaging the color forming member 90 after application of energy and the amount of energy applied to the color forming member 90 is derived from the image.

As the color forming member 90, it is possible to apply PRESCALE (registered trademark) (manufactured by FUJIFILM Corporation) with which a color formation density corresponding to applied pressure can be obtained. The PRESCALE is obtained by applying a color former including microcapsules in which colorless dye is included and a color developer to a sheet-shaped support. In a case where pressure is applied to the PRESCALE, the microcapsules are broken, the colorless dye is adsorbed to the color developer, and a color is formed. In addition, since the color former includes a plurality of kinds of microcapsules having different sizes and strengths, the number of microcapsules that are broken depends on pressure applied to the PRESCALE and color optical density also depends on pressure applied to the PRESCALE. Therefore, by observing the color optical density, the magnitude of the pressure applied to the PRESCALE, pressure distribution, and the like can be measured.

In addition, for example, as the color forming member 90, THERMOSCALE (a product name) (manufactured by FUJIFILM Corporation) which forms a color corresponding to the amount of heat, UVSCALE (a product name) (manufactured by FUJIFILM Corporation) which forms a color corresponding to the amount of ultraviolet rays, or the like may also be applied.

The server 4 is a general-purpose computer in which a software program that provides a function of a database management system (DBMS) has been installed. The server 4 acquires, from the information processing apparatus 10, a captured image 50, the amount of energy derived from the captured image 50, and accessory information (details will be described later), and the captured image 50, the amount of energy, and the accessory information are stored in the database 6. Note that the way in which the server 4 and the database 6 are connected to each other is not particularly limited and for example, the server 4 and the database 6 may be connected to each other via a data bus or may be connected to each other via a network such as a network attached storage (NAS) and a storage area network (SAN).

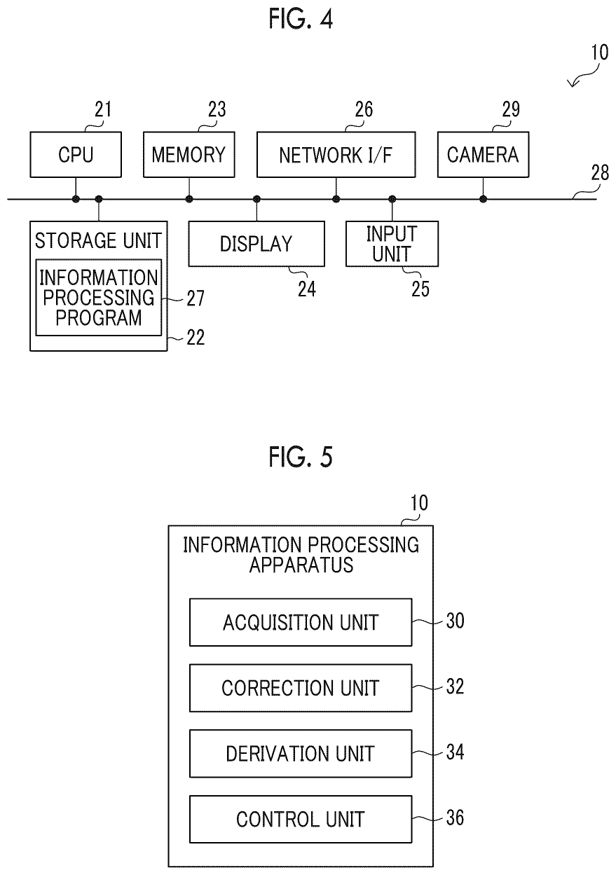

In the information processing system 1, as shown in FIG. 2, a user performs imaging by using a camera 29 (refer to FIG. 4) included in the information processing apparatus 10 in a state where the color forming member 90 is placed on a calibration member 80. Accordingly, the information processing apparatus 10 acquires the captured image 50 including the calibration member 80 and the color forming member 90. In a case where the user performs imaging in such a manner, the captured image 50 may be influenced by an illumination environment in which the imaging is performed, the characteristics of the camera 29, an imaging angle, an imaging distance, and the like. The calibration member 80 is for correction of the influences thereof on the captured image 50.

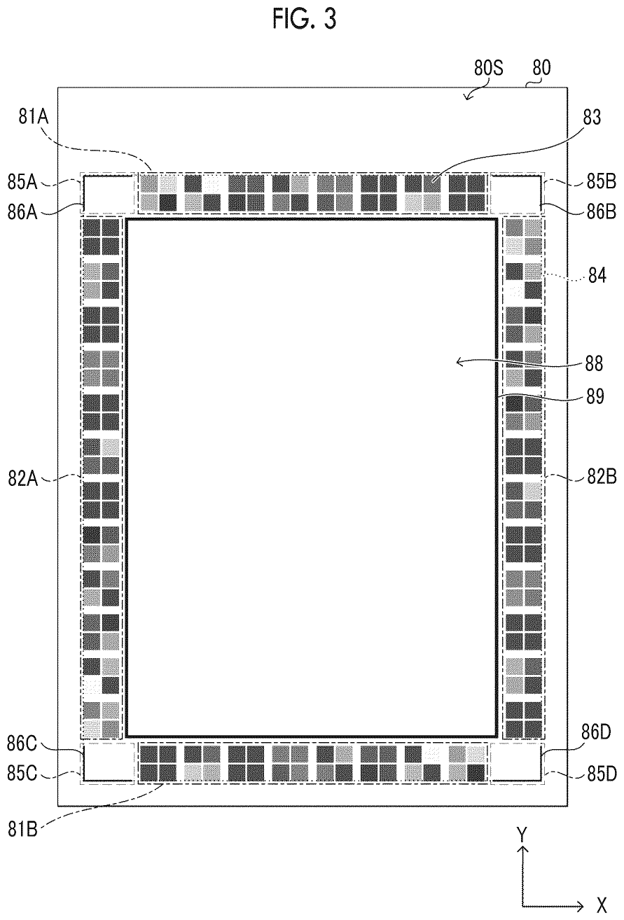

The calibration member 80 will be described in detail with reference to FIG. 3. The calibration member 80 is a support formed in a sheet-like shape or a plate-like shape, the support being configured to include, for example, paper, a resin, or the like. FIG. 3 shows a surface (hereinafter, referred to as an “imaging target surface 80S”) of the calibration member 80 that is imaged in a state where the color forming member 90 is placed thereon. An X direction in FIG. 3 is an example of a first direction according to the embodiment of the present disclosure, and a Y direction is an example of a second direction according to the embodiment of the present disclosure.

As shown in FIG. 3, the imaging target surface 80S includes a central region 88 on which the color forming member 90 is placed. In addition, it is preferable that the imaging target surface 80S includes a frame 89 that surrounds the outer edges of the central region 88. With the frame 89, the information processing apparatus 10 can perform correction of the distortion, the inclination, and the size of the captured image 50 (details will be described later). In particular, in a case where the frame 89 (that is, the central region 88) is rectangular, the accuracy of the correction of the distortion, the inclination, and the size of the captured image 50 can be improved. Therefore, it is preferable that the frame 89 is rectangular.

In addition, the imaging target surface 80S includes a pair of first patch groups 81A and 81B including a plurality of patches 83 that extend in the X direction and facing each other with the central region 88 interposed therebetween. The first patch group 81A and/or the first patch group 81B may include the plurality of patches 83 having different colors. For example, the first patch group 81A and/or the first patch group 81B may include the plurality of patches 83 having the same hue and different densities. In other words, the colors of the plurality of patches 83 included in the first patch group 81A and/or the first patch group 81B may be different from each other.

The colors and the number of the patches 83 included in one (for example, the first patch group 81A) of the pair of first patch groups 81A and 81B may be the same as the colors and the number of the patches 83 included in the other (for example, the first patch group 81B) of the pair of first patch groups. FIG. 3 shows an embodiment in which the patches 83 included in the first patch groups 81A and 81B are the same as each other in color and number but the arrangement of the patches 83 of respective colors is different between the patch groups. In addition, regarding the first patch groups 81A and 81B, as shown in FIG. 3, a plurality of patches may be arranged in the Y direction also as long as the number (16 in the example shown in FIG. 3) of patches 83 arranged in the X direction is larger than the number (two in the example shown in FIG. 3) of patches 83 arranged in the Y direction.

In addition, the imaging target surface 80S includes a pair of second patch groups 82A and 82B including the plurality of patches 83 that extend in the Y direction intersecting the X direction and facing each other with the central region 88 interposed therebetween. The second patch group 82A and/or the second patch group 82B may include the plurality of patches 83 having different colors. For example, the second patch group 82A and/or the second patch group 82B may include the plurality of patches 83 having the same hue and different densities. In other words, the colors of the plurality of patches 83 included in the second patch group 82A and/or the second patch group 82B may be different from each other.

The colors and the number of the patches 83 included in one (for example, the second patch group 82A) of the pair of second patch groups 82A and 82B may be the same as the colors and the number of the patches 83 included in the other (for example, the second patch group 82B) of the pair of second patch groups 82A and 82B. FIG. 3 shows an embodiment in which the patches 83 included in the second patch groups 82A and 82B are the same as each other in color and number but the arrangement of the patches 83 of respective colors is different between the patch groups. In addition, regarding the second patch groups 82A and 82B, as shown in FIG. 3, a plurality of patches may be arranged in the X direction also as long as the number (24 in the example shown in FIG. 3) of patches 83 arranged in the Y direction is larger than the number (two in the example shown in FIG. 3) of patches 83 arranged in the X direction.

The number of patches 83 included in the first patch groups 81A and 81B may be different from the number of patches 83 included in the second patch groups 82A and 82B. In FIG. 3, the number of patches 83 included in the first patch groups 81A and 81B is 32 and the number of patches 83 included in the second patch groups 82A and 82B is 48.

The color of at least one patch 83 included in the first patch group 81A and/or the first patch group 81B may be the same as the color of at least one patch 83 included in the second patch group 82A and/or the second patch group 82B. In other words, the patch 83 having the same color as the patch 83 included in the first patch group 81A and/or the first patch group 81B may be included in the second patch group 82A and/or the second patch group 82B. In a case where the patches 83 having the same color as each other are included in the first patch group 81A and/or the first patch group 81B and the second patch group 82A and/or the second patch group 82B, the accuracy of calibration of the captured image 50 that is performed by means of the information processing apparatus 10 can be improved (details will be described later).

For example, the colors of the plurality of patches 83 included in the first patch groups 81A and 81B and the second patch groups 82A and 82B may be similar to a color in the case of color formation of the color forming member 90. In addition, for example, the colors of the plurality of patches 83 included in the first patch groups 81A and 81B and the second patch groups 82A and 82B may include a color chart, a gray chart, or the like commonly used for calibration of each color such as RGB and neutral gray. In this case, the patches 83 of respective colors may be randomly disposed in the first patch groups 81A and 81B and the second patch groups 82A and 82B such that there is no imbalance in terms of hue and chroma saturation.

The plurality of patches 83 included in the first patch groups 81A and 81B and the second patch groups 82A and 82B may be the same as each other in at least one of size, shape, or angle. In FIG. 3, the plurality of patches 83 included in the first patch groups 81A and 81B and the second patch groups 82A and 82B have rectangular shapes that are the same as each other in size and angle.

In addition, it is preferable that the imaging target surface 80S includes a blank region disposed between a first patch group and a second patch group included in at least one of combinations of the first patch group and the second patch group that are adjacent to each other in a circumferential direction of the central region 88. Specifically, the expression “combinations of a first patch group and a second patch group that are adjacent to each other in the circumferential direction of the central region 88” means four combinations, which are a combination of the first patch group 81A and the second patch group 82A, a combination of the first patch group 81A and the second patch group 82B, a combination of the first patch group 81B and the second patch group 82A, and a combination of the first patch group 81B and the second patch group 82B. In FIG. 3, the imaging target surface 80S includes four blank regions 85A to 85D each of which is disposed between a first patch group and a second patch group that are adjacent to each other in the circumferential direction of the central region 88 (that is, the blank regions 85A to 85D are disposed for all of the above-described four combinations).

In addition, it is preferable that the imaging target surface 80S includes figures disposed in the blank regions each disposed between a first patch group and a second patch group. The figures are for showing a range that is to be included in the angle of view in a case where a user images the calibration member 80 and the color forming member 90. Therefore, it is preferable that the imaging target surface 80S includes four FIGS. 86A to 86D, which are respectively disposed at the four blank regions 85A to 85D as shown in FIG. 3, so that the range to be included in the angle of view is easily figured out. In FIG. 3, the shapes of the four FIGS. 86A to 86D are similar to each other.

Specifically, it is desired that the captured image 50 includes the color forming member 90, the first patch groups 81A and 81B, and the second patch groups 82A and 82B. Therefore, it is preferable that the four FIGS. 86A to 86D are figures respectively showing four corners of a rectangle 84 that has, as parts of the sides thereof, line segments disposed on extension lines of outer edges of the pair of first patch groups 81A and 81B and the pair of second patch groups 82A and 82B. That is, the rectangle 84 is a figure that encompasses the first patch groups 81A and 81B, the second patch groups 82A and 82B, and the color forming member 90 placed in the central region 88. By performing imaging such that the four FIGS. 86A to 86D showing the four corners of the rectangle 84 are included in the angle of view, it is possible to perform imaging such that the first patch groups 81A and 81B, the second patch groups 82A and 82B, and the color forming member 90 placed in the central region 88 are also included in the angle of view.

Next, the information processing apparatus 10 will be described in detail. First, an example of a hardware configuration of the information processing apparatus 10 will be described with reference to FIG. 4. As shown in FIG. 4, the information processing apparatus 10 includes a central processing unit (CPU) 21, a non-volatile storage unit 22, and a memory 23 which is a temporary storage area. In addition, the information processing apparatus 10 includes a display 24, such as a liquid crystal display, an input unit 25, a network interface (I/F) 26, and the camera 29. The CPU 21, the storage unit 22, the memory 23, the display 24, the input unit 25, the network I/F 26, and the camera 29 are connected to each other via a bus 28 such as a system bus and a control bus so that various types of information can be exchanged therebetween.

The storage unit 22 is realized by, for example, a storage medium, such as a hard disk drive (HDD), a solid state drive (SSD), and a flash memory. An information processing program 27 in the information processing apparatus 10 is stored in the storage unit 22. The CPU 21 reads out the information processing program 27 from the storage unit 22, loads the information processing program 27 into the memory 23, and executes the loaded information processing program 27. The CPU 21 is an example of a processor according to the embodiment of the present disclosure and the information processing program 27 is an example of a calibration program according to the embodiment of the present disclosure.

The input unit 25 is for reception of an operation performed by a user, and is, for example, a touch panel, a button, a keyboard, a mouse, or the like. The network I/F 26 performs wired or wireless communication with the server 4 and other external devices (not shown). The camera 29 includes a sensor having a plurality of different spectral sensitivities, images a subject by means of the sensor under the control of the CPU 21, and outputs an image signal of the captured image 50. As the information processing apparatus 10, for example, a smartphone, a tablet terminal, a wearable terminal, a personal computer, or the like having a camera function can be applied as appropriate. The information processing apparatus 10 is an example of a calibration apparatus according to the embodiment of the present disclosure.

Next, an example of a functional configuration of the information processing apparatus 10 will be described with reference to FIG. 5. As shown in FIG. 5, the information processing apparatus 10 includes an acquisition unit 30, a correction unit 32, a derivation unit 34, and a control unit 36. With the CPU 21 executing the information processing program 27, the CPU 21 functions as each of functional units which are the acquisition unit 30, the correction unit 32, the derivation unit 34, and the control unit 36.

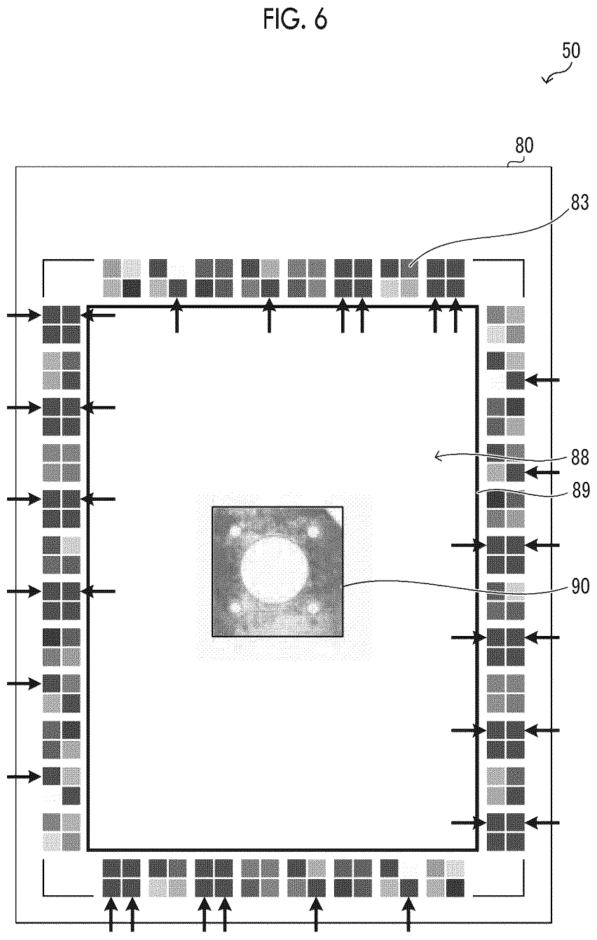

The acquisition unit 30 acquires the captured image 50 that includes the calibration member 80 and the color forming member 90 included in the central region 88 of the calibration member 80, which are imaged by the camera 29. FIG. 6 shows an example of the captured image 50. The captured image 50 is an example of an image according to the embodiment of the present disclosure.

The correction unit 32 extracts the frame 89 from the captured image 50 and corrects at least one of the distortion, the inclination, or the size of the captured image 50 based on the shape of the extracted frame 89. As a method of extracting the frame 89, a known method in which edge extraction processing or the like in an image is used can be applied as appropriate. Specifically, in a case where the frame 89 is rectangular, the correction unit 32 performs projective transformation, affine transformation, and the like such that an angle of 90 degrees is formed at each of four corners of the frame 89 extracted from the captured image 50 and corrects the distortion, the inclination, and the size of the captured image 50.

In addition, the correction unit 32 performs calibration with respect to the captured image 50 acquired by the acquisition unit 30 by using the patches 83 included in the captured image 50. Specifically, the correction unit 32 performs calibration of the color of the color forming member 90 (for example, the hue and/or the density thereof) included in the captured image 50 based on the colors of the first patch groups 81A and 81B and the second patch groups 82A and 82B included in the captured image 50. As a method for the calibration, a known method can be applied as appropriate. For example, a reference color may be stored in the storage unit 22 in advance for each of the patches 83 that the calibration member 80 includes and the correction unit 32 may adjust the color of the captured image 50 such that each of the colors of the patches 83 included in the captured image 50 coincides with the reference color.

In addition, as described above, each of the first patch groups 81A and 81B and the second patch groups 82A and 82B may include the patches 83 having the same color as each other. In this case, the patches 83, which are formed to originally have the same color as each other, may be expressed in different colors in the captured image 50 due to the influence of an illumination environment in which the imaging is performed, the characteristics of the camera 29, an imaging angle, an imaging distance, and the like. Therefore, for example, the correction unit 32 may adjust the color of the captured image 50 such that the average color of the patches 83 in the captured image 50 coincides with a reference color, the patches 83 being formed to have the same color as each other. In addition, for example, the correction unit 32 may adjust the color of the captured image 50 such that the color of the patch 83, of which the color in the captured image 50 is closest to a reference color among the patches 83 formed to have the same color as each other, coincides with the reference color.

Note that the correction unit 32 may perform calibration by using a part of the plurality of patches 83 included in the first patch groups 81A and 81B and the second patch groups 82A and 82B included in the captured image 50. For example, the correction unit 32 may perform calibration of the captured image 50 by using only the patches 83 to which arrows are added among all the patches 83 included in the captured image 50 shown in FIG. 6.

In addition, for example, the patch 83 used for calibration performed by the correction unit 32 may differ depending on the type of the color forming member 90. For example, regarding PRESCALE which is an example of the color forming member 90, a plurality of kinds of PRESCALE for a low pressure, a medium pressure, a high pressure, and the like of which the measurable pressure ranges are different from each other are manufactured. In addition, for example, as the color forming member 90, THERMOSCALE, UVSCALE, and the like also can be used instead of PRESCALE.

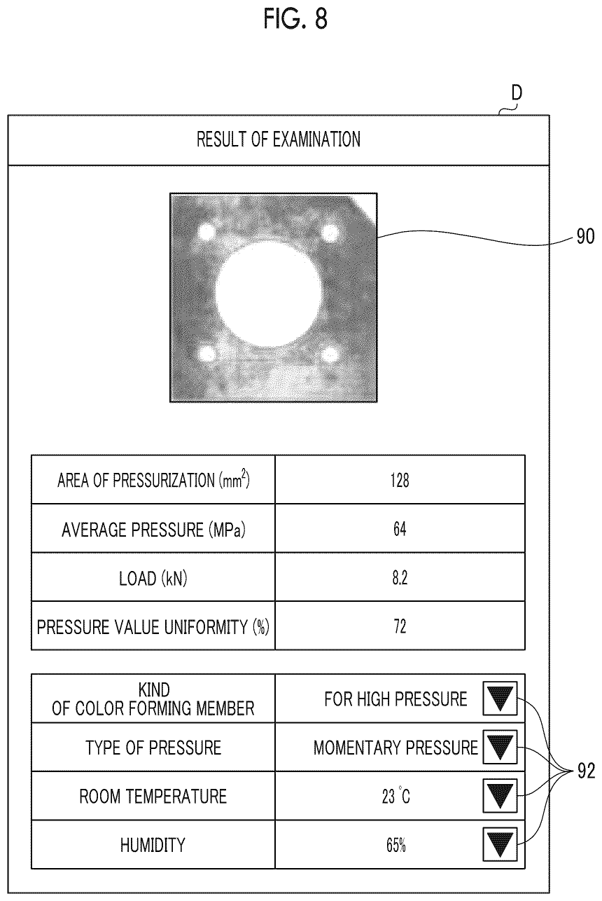

Therefore, the correction unit 32 may perform calibration by using a part of the plurality of patches 83 included in the first patch groups 81A and 81B and the second patch groups 82A and 82B included in the color forming member image 50, the part of the patches 83 being determined in advance in accordance with the type of the color forming member 90 included in the captured image 50. A correspondence relationship between the type of the color forming member 90 and the patches 83 used for calibration may be stored in, for example, the storage unit 22 in advance. The type of the color forming member 90 included in the captured image 50 may be input by, for example, a user via the input unit 25 (refer to FIG. 8) or an identification code indicating the type of the color forming member 90 may be attached to the color forming member 90 so that the type of the color forming member 90 is specified in a case where the identification code is read by the correction unit 32.

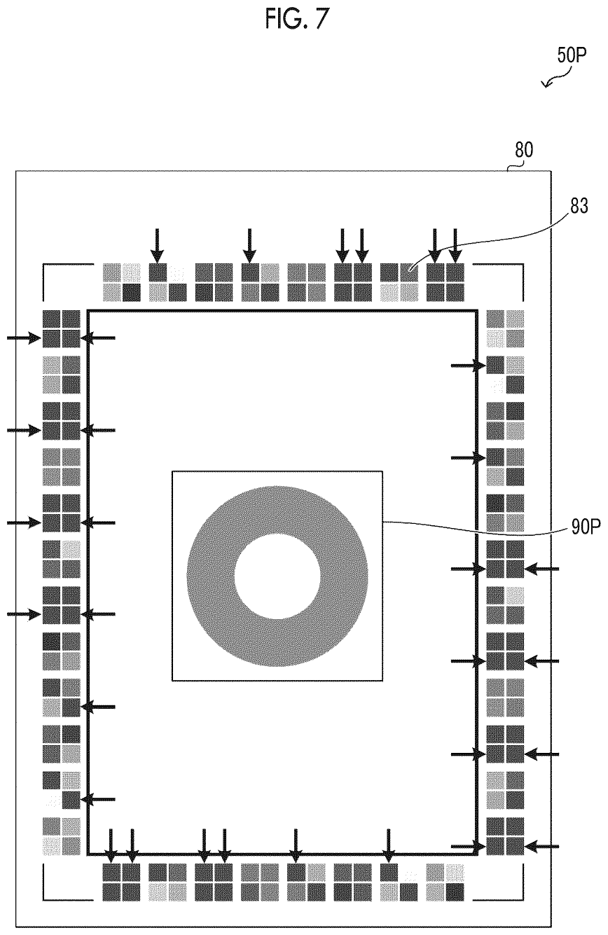

FIG. 7 shows an example of a captured image 50P different from the captured image 50 of FIG. 6. The captured image 50P is an image captured in a state where a color forming member 90P, of which the type is different from that of the color forming member 90 in FIG. 6, is placed on the calibration member 80 which is the same as the calibration member 80 in FIG. 6. The patches 83 to which arrows are added in FIG. 7 are different from the patches 83 to which the arrows are added in FIG. 6. The correction unit 32 may perform calibration of the captured image 50P by using only the patches 83 to which the arrows are added among all the patches 83 included in the captured image 50P shown in FIG. 7.

Since the correction unit 32 performs correction of the distortion, the inclination, the size, and the color of the captured image 50 in such a manner, the influence of an illumination environment in which imaging is performed, the characteristics of the camera 29, an imaging angle, an imaging distance, and the like that may be caused in a case where a user performs imaging can be corrected.

The derivation unit 34 derives the amount of energy applied to the color forming member 90 based on the color of the color forming member 90 after the calibration performed by the correction unit 32. Specifically, data in which a relationship between the amount of energy applied to the color forming member 90 and the color of the color forming member 90 is determined in advance may be stored in the storage unit 22 in advance, and the derivation unit 34 may convert the color of the color forming member 90 included in the captured image 50 into the amount of energy by using the data. In addition, the data in which the relationship between the amount of energy applied to the color forming member 90 and the color of the color forming member 90 is determined in advance may be prepared and stored in the storage unit 22 for each type of color forming member 90.

In addition, the derivation unit 34 may derive various indicators related to the amount of energy applied to the color forming member 90. Examples of the various indicators include energy distribution, which is obtained by deriving the amount of energy for each pixel of a region (hereinafter, referred to as a “color formation region”) of the color forming member 90 in which a color has been formed, and representative values such as the maximum value, the minimum value, the average value, and the median of the amounts of energy in the color formation region. In addition, examples of the various indicators include the area of the color formation region, the proportion of the area of a portion of the color formation region in which the amount of energy falls within a predetermined range, the uniformity in amount of energy in the color formation region, a load (the product of the area of the color formation region and the average value of the amount of energy) at the color formation region, and the like. In addition, in a case where a reference for the degree of color formation (that is, the amount of energy and energy distribution) of the color forming member 90 is determined in advance, examples of the various indicators include the rate of match or the rate of deviation with respect to the reference.

The control unit 36 performs control such that the captured image 50 that has been corrected for the distortion, the inclination, the size, and the color by the correction unit 32 and the various indicators that are derived by the derivation unit 34 and that are related to the amount of energy are displayed on the display 24. FIG. 8 shows an example of a screen D displayed on the display 24 by the control unit 36. On the screen D, an image of a part of the captured image 50 in FIG. 6 that corresponds to the color forming member 90 and various indicators that are derived from the color forming member 90 are displayed.

As shown on the screen D, the control unit 36 may perform control such that a part of the captured image 50 that corresponds to the color forming member 90 is extracted from the captured image 50 and is displayed on the display 24. Note that the “area of pressurization” on the screen D means the area of the above-described color formation region. The “average pressure” means the average value of the amounts of energy in the above-described color formation region. The “load” means the product of the area of pressurization and the average pressure. The “pressure value uniformity” means the pressure value uniformity in the color formation region.

In addition, accessory information related to the captured image 50 may be input to the control unit 36. On the screen D, as an example of the accessory information related to the captured image 50, the kind of the color forming member 90, the type of pressure, the room temperature, and the humidity are displayed and pull-down menus 92 for the inputting of the kind of the color forming member 90, the type of pressure, the room temperature, and the humidity are displayed. Note that examples of the “type of pressure” include momentary pressure indicating the magnitude of pressure momentarily applied to the PRESCALE and continuous pressure indicating the time-integral of the magnitude of pressure continuously applied to the PRESCALE. In addition, examples of the accessory information include identification information of the calibration member 80, the color forming member 90, a user who has applied energy to the color forming member 90, and a user who has imaged the color forming member 90, the result of an evaluation that is performed by a user for the amount of energy, and various examination conditions.

In addition, the control unit 36 transmits, to the server 4 via the network I/F 26, at least one of the captured image 50 before correction performed by the correction unit 32, the captured image 50 after the correction, or an image of a part of the captured image 50 that corresponds to the color forming member 90 and that is extracted from the captured image 50. In addition, the control unit 36 transmits, to the server 4, the various indicators that are derived by the derivation unit 34 and that are related to the amount of energy and the accessory information input thereto. The server 4 associates and stores information received from the information processing apparatus 10 (the control unit 36) in the database 6.

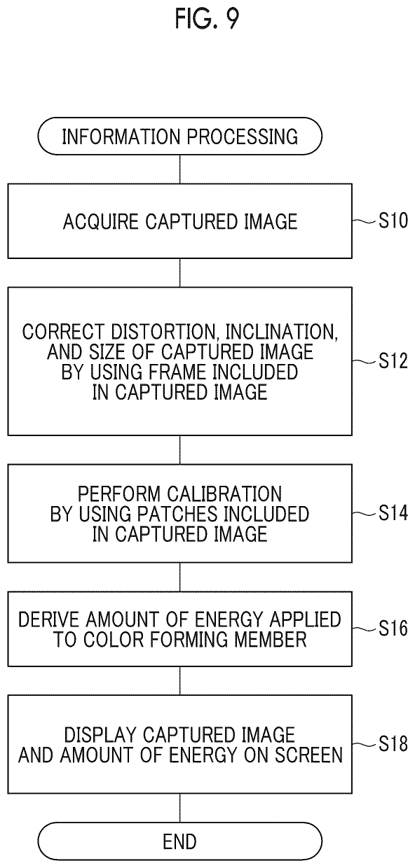

Next, the action of the information processing apparatus 10 according to the present embodiment will be described with reference to FIG. 9. In the information processing apparatus 10, the CPU 21 executes the information processing program 27 so that information processing shown in FIG. 9 is executed. The information processing is executed, for example, in a case where a user gives an instruction to start execution via the input unit 25.

In step S10, the acquisition unit 30 acquires the captured image 50 including the calibration member 80 and the color forming member 90 imaged by the camera 29. Next, in step S12, the correction unit 32 extracts the frame 89 from the captured image acquired in step S10 and corrects at least one of the distortion, the inclination, or the size of the captured image 50 based on the shape of the extracted frame 89. Next, in step S14, the correction unit 32 performs calibration of the color of the captured image 50 (particularly, the color forming member 90 included in the captured image 50) by using the patches 83 included in the captured image 50 corrected in step S12.

In step S16, the derivation unit 34 derives the amount of energy applied to the color forming member 90 based on the color of the color forming member 90 subjected to the calibration in step S14. In step S18, the control unit 36 performs control such that the captured image 50 subjected to the calibration in step S14 and the amount of energy derived in step S16 are displayed on the display 24, and the information processing ends.

As described above, the calibration member 80 according to an aspect of the present disclosure is a calibration member including the imaging target surface 80S. The imaging target surface 80S includes the central region 88, the pair of first patch groups 81A and 81B including the plurality of patches 83 that extend in a first direction (the X direction) and facing each other with the central region 88 interposed therebetween, the pair of second patch groups 82A and 82B including the plurality of patches 83 that extend in a second direction (the Y direction) intersecting the first direction and facing each other with the central region 88 interposed therebetween, a blank region disposed between a first patch group and a second patch group included in at least one of combinations of the first patch group and the second patch group that are adjacent to each other in the circumferential direction of the central region 88, and a figure disposed in the blank region. The calibration member 80 is for performing, by using the patches 83, calibration with respect to an image obtained by imaging the imaging target surface 80S.

With such a calibration member 80, a user can recognize a range to be included in the angle of view with the figure disposed in the blank region. Therefore, it is possible to perform imaging such that the first patch groups 81A and 81B, the second patch groups 82A and 82B, and the color forming member 90 are also included in the angle of view in a case where the color forming member 90 is imaged after being placed on the central region 88. Therefore, it is possible to support appropriate measurement of the amount of energy in which the color forming member 90 is used.

In addition, the calibration member 80 according to another aspect of the present disclosure is a calibration member including the imaging target surface 80S. The imaging target surface 80S includes the central region 88, the frame 89 surrounding outer edges of the central region 88, the pair of first patch groups 81A and 81B including the plurality of patches 83 that extend in the first direction (the X direction) and facing each other with the central region 88 interposed therebetween, and the pair of second patch groups 82A and 82B including the plurality of patches 83 that extend in the second direction (the Y direction) intersecting the first direction and facing each other with the central region 88 interposed therebetween. The calibration member 80 is for performing, by using the patches 83, calibration with respect to an image obtained by imaging the imaging target surface 80S.

With such a calibration member 80, it is possible to correct, by using the frame 89, at least one of the distortion, the inclination, or the size of the captured image 50 obtained by imaging the imaging target surface 80S. Therefore, it is possible to support appropriate measurement of the amount of energy in which the color forming member 90 included in the captured image 50 is used.

Note that although an embodiment in which the information processing apparatus 10 includes the camera 29 has been described in the above-described embodiment, the present disclosure is not limited thereto. For example, the information processing apparatus 10 may not include the camera 29 and an image captured by an external digital camera or the like may be acquired as the captured image 50.

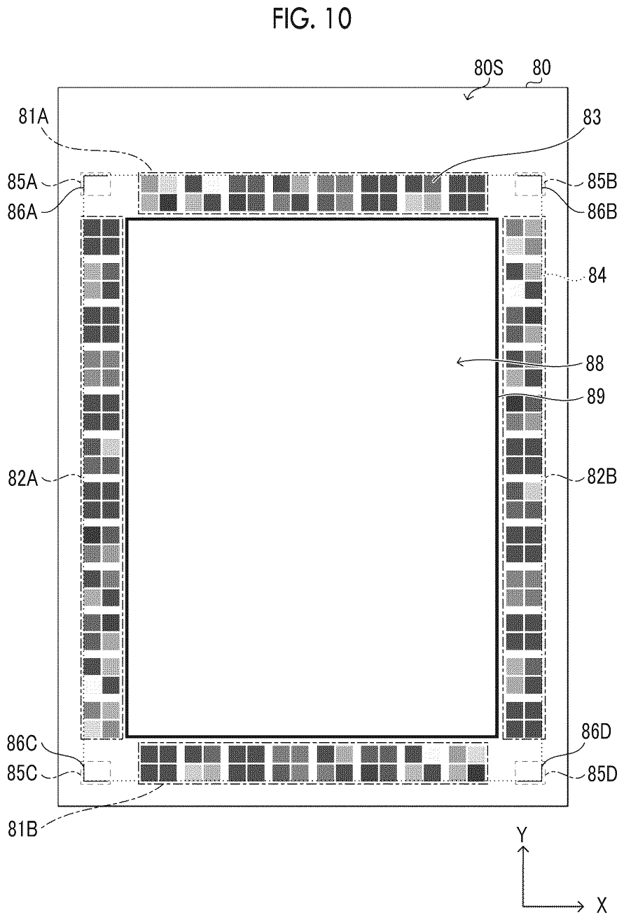

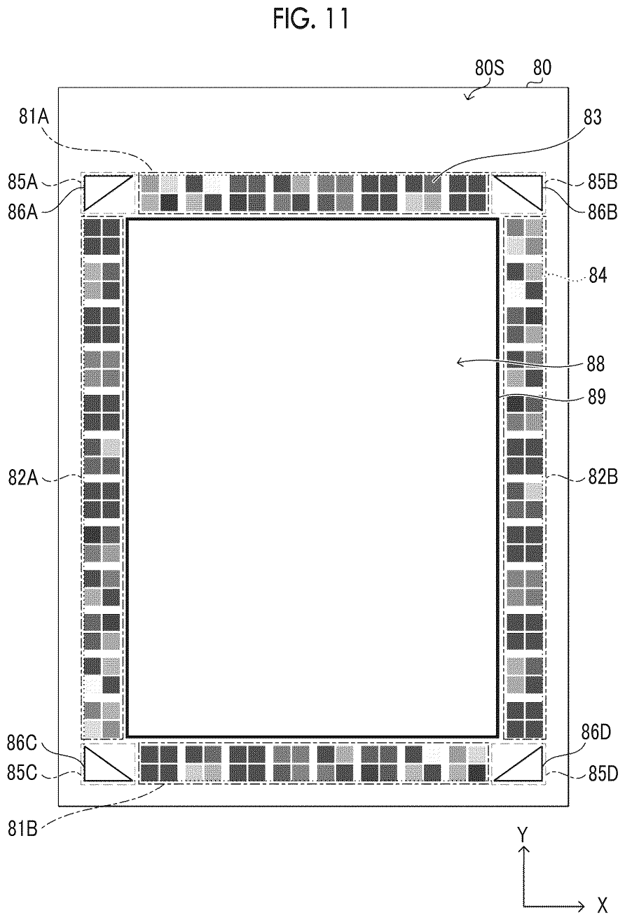

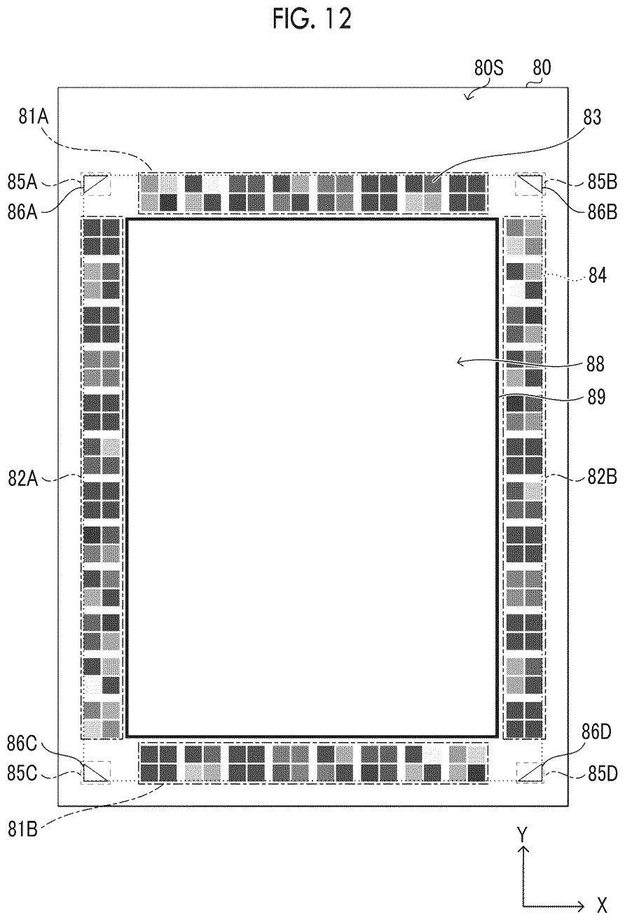

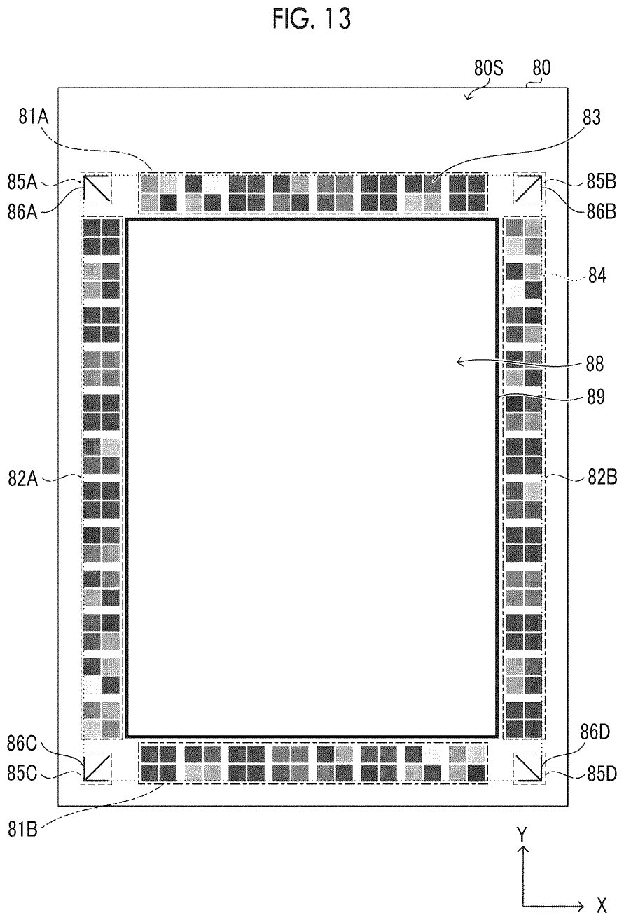

In addition, FIGS. 10 to 13 show examples of the calibration member 80 according to other embodiments of the present disclosure. The calibration members 80 shown in FIGS. 10 to 13 have the same elements as the calibration member 80 shown in FIG. 3. However, the sizes and/or shapes of the FIGS. 86A to 86D thereof are different from each other. In any of FIGS. 10 to 13, the four FIGS. 86A to 86D are figures respectively showing four corners of the rectangle 84 that has, as parts of the sides thereof, line segments disposed on extension lines of outer edges of the pair of first patch groups 81A and 81B and the pair of second patch groups 82A and 82B.

In addition, in the above-described embodiment, for example, various processors as follows can be used as the hardware structure of a processing unit that executes various kinds of processing, such as the acquisition unit 30, the correction unit 32, the derivation unit 34, and the control unit 36. As described above, the various processors include a programmable logic device (PLD) as a processor of which the circuit configuration can be changed after manufacture, such as a field programmable gate array (FPGA), a dedicated electrical circuit as a processor having a dedicated circuit configuration for executing specific processing such as an application specific integrated circuit (ASIC), and the like, in addition to the CPU as a general-purpose processor that functions as various processing units by executing software (program).

One processing unit may be composed of one of the various processors or may be composed of a combination of two or more processors of the same type or different types (for example, a combination of a plurality of FPGAs or a combination of a CPU and an FPGA). In addition, a plurality of processing units may be composed of one processor.

As an example of the plurality of processing units composed of one processor, first, the present disclosure includes an aspect in which one processor is composed of a combination of one or more CPUs and software, and the processor functions as the plurality of processing units, as represented by a computer such as a client and a server. Second, the present disclosure includes an aspect of using a processor that implements functions of the entire system including the plurality of processing units in one integrated circuit (IC) chip, as represented by a system on chip (SoC). As described above, various processing units are configured by using one or more of the above-described various processors as the hardware structure.

Furthermore, more specifically, an electric circuit (circuitry) in which circuit elements such as semiconductor elements are combined can be used as the hardware structure of the various processors.

In addition, in each exemplary embodiment described above, an aspect in which the information processing program 27 is stored in the storage unit 22 in advance has been described. However, the present disclosure is not limited thereto. The information processing program 27 may be provided in a state of being recorded on a recording medium, such as a compact disc read only memory (CD-ROM), a digital versatile disc read only memory (DVD-ROM), or a universal serial bus (USB) memory. In addition, the information processing program 27 may be downloaded from an external device via a network. Furthermore, in addition to the information processing program, the present disclosed technology is applied to a storage medium that stores the information processing program in a non-transitory manner.

In the present disclosed technology, the above-described exemplary embodiment and an example can be appropriately combined with each other. Contents described and shown above are for detailed description of a part according to the present disclosed technology and are merely an example of the present disclosed technology. For example, description of the above-described configurations, functions, actions, and effects is description related to an example of configurations, functions, actions, and effects of parts related to the present disclosed technology. Therefore, it is needless to say that unnecessary parts may be deleted, or new elements may be added or replaced with respect to the above-described contents and illustrated contents within a scope not departing from the spirit of the present disclosed technology.

What is claimed is:

1. A calibration member comprising an imaging target surface including:
a central region,
a frame surrounding an outer edge of the central region,
a pair of first patch groups including a plurality of patches that extend in a first direction and facing each other with the central region interposed therebetween, and
a pair of second patch groups including a plurality of patches that extend in a second direction intersecting the first direction and facing each other with the central region interposed therebetween, and
the calibration member is for performing, by using the patches, calibration with respect to an image obtained by imaging the imaging target surface.

2. The calibration member according to claim 1,
wherein the frame has a rectangular shape.

3. The calibration member according to claim 1,
wherein the first patch group and the second patch group include the plurality of patches having different colors.

4. The calibration member according to claim 3,
wherein the first patch group and the second patch group include the plurality of patches having the same hue and different densities.

5. The calibration member according to claim 1,
wherein colors and the number of the patches included in one of the pair of first patch groups are the same as colors and the number of the patches included in the other of the pair of first patch groups, and
colors and the number of the patches included in one of the pair of second patch groups are the same as colors and the number of the patches included in the other of the pair of second patch groups.

6. The calibration member according to claim 1,
wherein a color of at least one patch included in the first patch group is the same as a color of at least one patch included in the second patch group.

7. The calibration member according to claim 1,
wherein the number of the patches included in the first patch group and the number of the patches included in the second patch group are different from each other.

8. The calibration member according to claim 1,
wherein the plurality of patches are the same as each other in at least one of size, shape, or angle.

9. The calibration member according to claim 1,
wherein each of the plurality of patches has a rectangular shape.

10. The calibration member according to claim 1,
wherein the imaging target surface includes
a blank region disposed between a first patch group and a second patch group included in at least one of combinations of the first patch group and the second patch group that are adjacent to each other in a circumferential direction of the central region, and
a figure disposed in the blank region.

11. The calibration member according to claim 10,
wherein the imaging target surface includes
four blank regions each of which is disposed between the first patch group and the second patch group that are adjacent to each other in the circumferential direction of the central region, and
four figures that are respectively disposed at the four blank regions.

12. The calibration member according to claim 11,
wherein shapes of the four figures are similar to each other.

13. The calibration member according to claim 11,
wherein the four figures are figures respectively showing four corners of a rectangle that has, as parts of sides thereof, line segments disposed on extension lines of outer edges of the pair of first patch groups and the pair of second patch groups.

14. A calibration apparatus comprising:
at least one processor that is configured to:
acquire an image including
a central region,
a frame surrounding an outer edge of the central region,
a pair of first patch groups including a plurality of patches that extend in a first direction and facing each other with the central region interposed therebetween, and
a pair of second patch groups including a plurality of patches that extend in a second direction intersecting the first direction and facing each other with the central region interposed therebetween; and
perform calibration with respect to the image by using the patches.

15. The calibration apparatus according to claim 14,
wherein the at least one processor is configured to:
extract the frame from the image; and
correct at least one of a distortion, an inclination, or a size of the image based on a shape of the extracted frame.

16. The calibration apparatus according to claim 14,
wherein the at least one processor is configured to perform calibration by using a part of the plurality of patches included in the first patch group and the second patch group included in the image.

17. The calibration apparatus according to claim 14,
wherein the central region in the image includes a color forming member, which forms a color with density distribution corresponding to an amount of energy applied thereto.

18. The calibration apparatus according to claim 17,
wherein the first patch group and the second patch group include the plurality of patches having different colors, and
the at least one processor is configured to perform calibration of a color of the color forming member included in the image based on colors of the first patch group and the second patch group included in the image.

19. The calibration apparatus according to claim 18,
wherein the at least one processor is configured to perform calibration by using a part of the plurality of patches included in the first patch group and the second patch group included in the image, the part of the plurality of patches being determined in advance in accordance with a type of the color forming member included in the image.

20. The calibration apparatus according to claim 18,
wherein the at least one processor is configured to derive the amount of energy applied to the color forming member based on the color of the color forming member after the calibration by using data in which a relationship between the amount of energy applied to the color forming member and the color of the color forming member included in the image is determined in advance.

21. A calibration method comprising:
acquiring an image including
a central region,
a frame surrounding an outer edge of the central region,
a pair of first patch groups including a plurality of patches that extend in a first direction and facing each other with the central region interposed therebetween, and
a pair of second patch groups including a plurality of patches that extend in a second direction intersecting the first direction and facing each other with the central region interposed therebetween; and
performing calibration with respect to the image by using the patches.

22. A non-transitory storage medium storing a program that causes a computer to execute calibration processing, the calibration processing comprising:
acquiring an image including
a central region,
a frame surrounding an outer edge of the central region,
a pair of first patch groups including a plurality of patches that extend in a first direction and facing each other with the central region interposed therebetween, and
a pair of second patch groups including a plurality of patches that extend in a second direction intersecting the first direction and facing each other with the central region interposed therebetween; and
performing calibration with respect to the image by using the patches.

23. The calibration member according to claim 1, wherein the central region is a region on which a color forming member is placed.

24. The calibration member according to claim 1, wherein the frame is a borderline formed on the imaging target surface.

25. The calibration apparatus according to claim 14, wherein the central region is a region on which a color forming member is placed.

26. The calibration apparatus according to claim 14, wherein the frame is a borderline formed on the image.

27. The calibration method according to claim 21, wherein the central region is a region on which a color forming member is placed.

28. The calibration method according to claim 21, wherein the frame is a borderline formed on the image.

29. The non-transitory storage medium according to claim 22, wherein the central region is a region on which a color forming member is placed.

30. The non-transitory storage medium according to claim 22, wherein the frame is a borderline formed on the image.
